(19) United States
(12) Patent Application Publication
(10) Pub. No.: US 2010/0001848 A1
(43) Pub. Date: Jan. 7, 2010

(54) Secure Modular Applicators to Commission Wireless Sensors

(76) Inventors: Clarke McAllister, Eugene, OR (US); Timothy Mintzer, Aumsville, OR (US)

Correspondence Address: PETER A. HAAS, ESQUIRE, 1929 SW 13TH AVENUE, PORTLAND, OR, 97201, US

(21) Appl. No.: 11/767,471

(22) Filed: Jun. 22, 2007

(51) Int. Cl. H04Q 5/22; H04K 1/00; B65D 85/00

(52) U.S. Cl. 340/10.51; 380/271; 206/307

(57) ABSTRACT

The present invention improves systems and devices for commissioning wireless tags, RFID tags, and wireless sensors. The present invention benefits wireless sensors that are not directly part of a demand printed label. In one embodiment RFID tags are pre-loaded into cartridges prior to consumption. This improvement adds significant convenience of loading RFID tags and enhances overall reliability of handling and applying the RFID tags. Accordingly, the present invention includes methods and devices that enable application and distribution of RFID tags in pre-loaded cartridges that are ready-to-use.

### PRIORITY CLAIM

This present application claims benefit under 35 U.S.C. Section 119(e) of U.S. Provisional Patent Application Ser. No. 60/805,777, filed on 26 Jun. 2006, the disclosure of which is expressly incorporated by reference for all purposes.

### BACKGROUND

The present invention relates to a system, including methods and devices, utilizing wireless sensor devices and RFID (radio-frequency identification) transponders. Specifically, the present invention relates to a system incorporating novel devices and methods that enable point-of-use and on-demand commissioning of RFID transponder-equipped wireless sensors.

Radio-frequency identification (RFID) transponders enable improved identification and tracking of objects by encoding data electronically in a compact tag or label. And, advantageously, the compact tag or label can optionally carry the same data that is encoded into one or more printed indicia such as bar codes. In fact, using the Gen2 EPC specification, or the equivalent ISO Standard 18000-6C an RFID transponder can carry as a subset of its entire data payload, data that is also represented by bar codes.

Radio-frequency identification (RFID) transponders are typically thin transceivers that include an integrated circuit chip having radio frequency circuits, control logic, memory and an antenna structure mounted on a supporting substrate, enable vast amounts of information to be encoded and stored and have unique identification. Commissioning, the process of encoding specific information (for example, data representing an object identifier, serial number, a date-code, batch, customer name, origin, destination, quantity, and items) associated with an object (for example, an item or a shipping container), associates a specific object with a unique RFID transponder. The commissioned transponder responds to coded RF signals and, therefore, readily can be interrogated by external devices to reveal the data associated with the transponder.

Current classes of RFID transponders rank into two primary categories: active RFID transponders and passive RFID transponders. Active RFID transponders include an integrated power source capable of self-generating signals, which may be used by other, remote reading devices to interpret the data associated with the transponder. Active transponders include batteries and, historically, are considered considerably more expensive than passive RFID transponders. Passive RFID transponders backscatter incident RF energy to specially designed remote devices such as interrogators.

Combining the benefits of the latest technology in RFID transponders with sensing devices, a broader class of devices called wireless sensors is emerging. Wireless sensors have a unique identity, sense one or more attributes within its environment, and report its identity and data corresponding to the sensed attributes. For example, a wireless sensor interprets environmental conditions such as temperature, moisture, sunlight, seismic activity, biological, chemical or nuclear materials, specific molecules, shock, vibration, location, or other environmental parameters. Wireless sensors are distributed nodes of computing networks that are interconnected by wired and wireless interfaces.

Wireless sensors, made using silicon circuits, polymer circuits, an encoded quartz crystal diode, or Surface Acoustic Wave (SAW) materials to affect radio frequency or other signaling methods, communicate wirelessly to other devices. For example, certain embodiments of wireless sensors communicate on a peer-to-peer basis to an interrogator or a mobile computer. Communication methods include narrow band, wide band, ultra wide band, or other means of radio or signal propagation methods.

Additional examples of RFID transponders, wireless tags, and wireless sensors are more fully discussed this inventor's co-pending U.S. Patent Application Publication No. 2006/0080819, entitled “Systems and Methods for Deployment and Recycling of RFID Tags, Wireless Sensors, and the Containers Attached thereto,” published on 20 Apr. 2006, which is incorporated by reference for all purposes in this document.

One problem of prior-art systems is the total cost for encoding and applying wireless sensors. In the case of manual encoding and application of RFID tags or wireless sensors, the cost is dominated by labor costs. Therefore business process integration plays a significant role in reducing the total cost of ownership of tagging objects. For example, in many supply chain applications, case picking is performed during the fulfillment of a customer order, this is an operation where individual cases or groups of cases are manually handled. Similarly in receiving of goods at retail, manufacturing, or distribution receiving docks are other business process where individual cases are manually handled. In either of these types of business processes where individual cartons are handled, there is an opportunity to encode and apply an RFID tag or wireless sensor to each carton on a selective basis.

### SUMMARY OF THE INVENTION

The present invention is directed to improved systems for commissioning wireless tags, RFID tags, and wireless sensors. The present inventors have recognized that significant benefits can be realized from using wireless sensors that are not directly part of a demand printed label. Among them include improved deployment yield and efficiency, and greater mobility for the tag commissioning process. RFID tags pre-loaded into cartridges prior to consumption adds significant convenience of loading RFID tags and overall reliability of the handling and applying of the RFID tags and also includes significant labor savings over current methods of hand loading loose rolls of RFID tags into RFID applicators. A security mechanism is used to ensure that only certain cartridges will operate with certain applicators. A fixed applicator is disclosed which when used in an array of similar applicators provides for hot swapping of empty cartridges on a continuous conveyor line.

### DRAWINGS

FIG. 1 is an orthogonal rear side view of a belt-mounted or desktop version of an RFID tag applicator and cartridge according to one embodiment of the present invention.

FIG. 2 is an orthogonal front view of a belt-mounted or desktop version of an RFID tag applicator and cartridge according to one embodiment of the present invention.

FIG. 3 illustrates a tag at a programming position against a cartridge peel plate.

FIG. 4 illustrates a tag being rejected onto the take-up reel of a cartridge.

FIG. 5 illustrates a metal mount tag being peeled from its release liner.

FIG. 6 illustrates two slots for mounting a peel plate into a cartridge body.

FIG. 7 illustrates two slots for mounting a peel plate into a cartridge cover.

FIG. 8 is a photo of a near field coupler used for programming tags.

FIG. 9 is a fixed applicator and cartridge according to one embodiment of the present invention.

FIG. 10 is an array of cartridge-fed fixed RFD tag applicators according to one embodiment of the present invention.

FIG. 11 is a diagram of a method of password protection of RFID tag data.

FIG. 12 is a diagrammatic view of a system to secure and control authorized access to wireless sensors in an open system of use.

FIG. 13 is an AES Encryption Implementation for secure RFID tags.

FIG. 14 is a block diagram of a system to provide power and communications to portable tag encoders operating in remote areas.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

Certain preferred embodiments are directed to methods for tagging metal objects such as aircraft, boats, or automotive parts, tools, equipment, hospital assets, or other manufactured goods with metal surfaces. Certain preferred embodiments are also directed to methods for tagging transportation containers, airline baggage, apparel, pharmaceuticals, manufactured items, and retail goods. In most instances, the tagging methods will be described with reference to containers such as loaded pallets, paperboard boxes, corrugated cartons, pharmaceutical containers, and conveyable cases, but other containers may be used by these methods.

Certain preferred embodiments relate to commercial corrugated shipping cartons, RFID or wireless sensors, tagged pallet-loads of shrink-wrapped cases, consumer goods packaging, consumer goods, or to other various methods of tagging objects. Corrugated cases are typically constructed with an inner and an outer linerboard, between which a corrugated medium is glued.

Certain embodiments for providing the benefits of cartridge-based tag application are disclosed for cartons moving along conveyor lines. This document also discloses preferred embodiments that support operation and use of tag encoders in remote parts of the world where power and communications are not normally available, whereby extending the benefits of supply chain reporting to the head end of manufacturing processes anywhere in the world.

This document refers to transponders interchangeably with the term tags. A transponder is generally fabricated from an inlay and additional materials that may include a substrate material. An inlay is a thin segment of plastic such as PET that carries an antenna structure bonded to at least one RFID chip or other type of wireless sensor device. Though many of the embodiments herein are described with reference to various inlays, transponders and RFID tags, the methods and devices described herein may be applicable to other types of wireless tags, transponders, or wireless sensors. Wireless tags are a broad class of wireless devices that transmit and receive information wirelessly, have a unique identity, and optionally sense one or more attributes within its environment. Wireless tags include RFID transponders, RFID tags, RFID inlays, and wireless sensors. Wireless sensors are devices that report identity, and or some combination of additional information such as temperature, moisture, sunlight, seismic activity, biological, chemical or nuclear materials, specific molecules, shock, vibration, location, or other environmental parameters. Wireless tags are distributed nodes of computing networks that are interconnected by wired and wireless interfaces. Wireless tags may communicate on a peer-to-peer basis utilizing server based technologies, TCP/IP, FTP, and other commonly available digital communication protocols. Wireless tags may be made using silicon circuits, polymer circuits, optical modulation indicia, an encoded quartz crystal diode, or Surface Acoustic Wave (SAW) materials to affect radio frequency or other signaling methods. Wireless tags preferably communicate wirelessly to an interrogator, and certain preferred embodiments of wireless tags communicate on a peer-to-peer basis. Communication methods may include narrow band, wide band, ultra wide band, or other means of radio or signal propagation methods.

There are certain preferred transponder embodiments that include RFID tags or wireless sensors as a component. Other preferred tag embodiments include RFID inlays as a component.

This disclosure refers to objects that are associated with RFID tags and are referred to by the data within RFID tag memories. Such objects may include, but are not limited to: manufactured sub-assemblies, automobiles, aircraft, pharmaceuticals, medical supplies, electronic products or components, consumer goods, manufactured goods, fixed assets, apparel, waste containers, shipping containers, industrial equipment, tools, and transitory third party assets such as airline baggage consumer package handling and transportation.

HF is an acronym for High Frequency. HF RFID refers to the internationally approved band that is centered at 13.56 MHz and generally uses inductive coupling for its air interface. UHF is an acronym for Ultra High Frequency. UHF refers to the band of the electromagnetic spectrum that, for RFID applications, spans from about 860 MHz to 960 MHz. RFID tags responsive to this frequency band generally have some form of one or more dipoles in their antenna structure.

Ultra Wide Band (UWB) is a method of transmitting radio pulses across a very wide spectrum of frequencies that span several gigahertz of bandwidth. Modulation techniques include the use of Orthogonal Frequency Division Multiplexing (OFDM) to derive superior data encoding and data recovery from low power radio signals. OFDM and UWB provide a robust radio link in RF noisy or multi-path environments and improved performance through and around RF absorbing or reflecting materials compared to narrowband, spread spectrum, or frequency-hopping radio systems. UWB wireless sensors are preferably reused according to certain preferred methods disclosed herein. UWB wireless sensors may be combined with narrowband, spread spectrum, or frequency-hopping inlays or wireless sensors as disclosed herein.

Passive RFID refers to tags without batteries. Active tags have batteries and have been historically been considerably more expensive than passive RFID tags. Passive RFID tags backscatter incident RF energy. Active RFID tags often have their own transmitter and generally do not use backscatter for the return link. A battery assist tag is a sort of hybrid that uses a battery to power the RFID chip and a backscatter return link to the interrogator.

The RFID inlays are often comprised of an RFID chip bonded to an antenna, formed on a substrate that is often plastic such as Mylar®, polyester, or PET. Antennae may be formed by etching copper from the substrate, or from stamped aluminum foil, but an alternate method is to print multiple layers of conductive ink onto a substrate.

A preferred transponder design for use on metal objects is to place a layer of foam tape between an RFID tag and the metal object it is commissioned to. The thickness of the foam can vary, but is generally about 3/16 inch thick or less for use in the UHF band.

Certain preferred applicator and encoder embodiments use UHF wireless tags or UHF RFID tags such as Spec 3000709 from UPM Raflatac of Tampere, Finland, Model 9338 Squiggle Tag from Alien Technology of Morgan Hill, California, or Avery Dennison AD-220, or other wireless sensors. Such wireless sensors are preferably based on EPCglobal Gen1, EPCglobal Gen2, ISO18000-6C, or more recent standards and specifications. Certain other preferred embodiments read and encode HF tags such as SmartLabels manufactured by Texas Instruments of Dallas, Tex. Preferably wireless tags are manufactured to specifications that are compatible with encoder specifications as core diameter, outer diameter, and web width. Alternatively, certain preferred steps are required to prepare a standard roll of wireless sensors for use in an automated applicator/encoder, including unrolling from a large roll onto several smaller rolls having a smaller core diameter. Alternate preparation steps include fan-folding tags into a magazine or cartridge for transportation, handling, and subsequent use. Certain types of tags have no adhesive and are carried within a cartridge or magazine that fits into an encoder or applicator that later applies an adhesive at the time when a tag is encoded and commissioned for use.

Adhesive-backed tags are typically mounted onto a conveyance web made of paper or film substrates that are coated with a low surface energy material such as silicone. There are other earth-friendly paper coatings as well and are preferred wherever possible to reduce the amount of waste and environmental contamination. Silicones are known chemically as polyorganosiloxanes which are polymers with chains that contain between 1 and 1000 silicone atoms interspersed with an oxygen atom. Different organic groups can be attached to the backbone to modify the properties of the coating. Emulsion release coatings are water-base coatings that are an effective alternative to hydrocarbon solvent-based coatings.

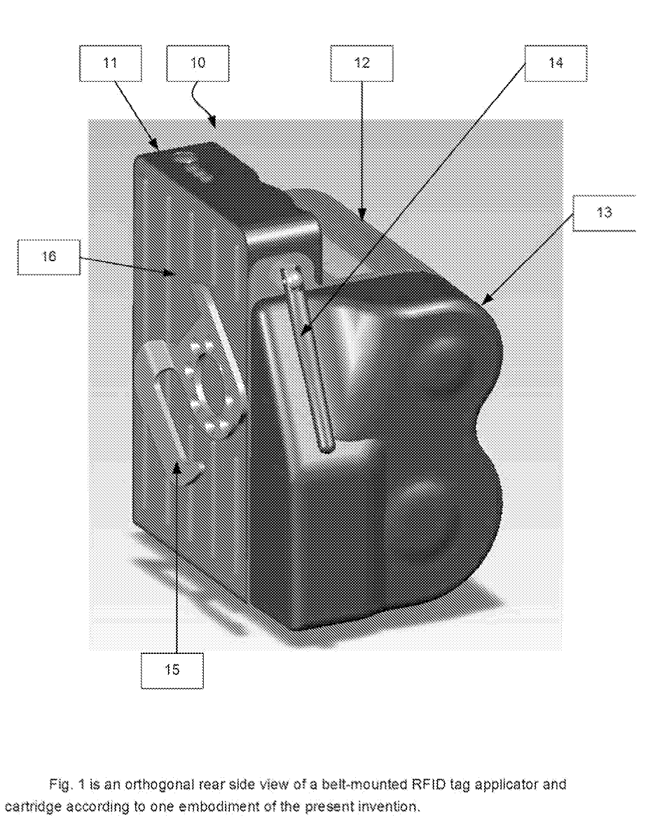

Portable tag encoder 10 is illustrated in FIG. 1. Encoder 10 is a preferred embodiment of a portable non-printing tag encoder having a means for encoding or reading wireless sensors while they are in protective cartridge 12, and having the ability to selectively peel away the conveyance web that retains and spatially organizes the tags within the cartridge.

RFID encoding devices that do not have a printing mechanism is a preferred embodiment of this new category of thickness-tolerant RFID encoding devices disclosed herein. This is because prior art printing mechanisms are intolerant of variations in media thickness. Media such as paper, tickets, and tags, including RFID tags are required to maintain a very high degree of flatness across the face stock material. This restriction is evidenced by even the slight bump that is caused by an RFID chip embedded under the face stock material of an RFID tag. Even modern printing mechanisms impose limitations to the overall thickness of the transponder as well as the aforementioned uniformity of transponder or label thickness. There are many applications where the additional cost, size, and weight of a printer mechanism is not clearly justifiable when RFID tag encoding is performed in a well controlled process to avoid human errors.

Pre-encoded tags can be delivered in cartridge 12 for applications in which encoder 10 is used only to read data from tags to support the tag commissioning process and report results to a host.

Preferred embodiments have a main structural body 11, electronics service panel 16, a mechanical service cover 13, a clasp, hook, or other means 15 for attachment to a person or another object. Preferred embodiments use special fasteners with security features to close, seal, and secure electronics service panel 16 to prevent unintended access. A preferred type of security feature has an unusual shape or fitting within the head of the fastener that prevents commonly available tools from removing the fasteners. A preferred shape is a center post that protrudes up from within the head to prevent common tools from engaging with the head.

Preferred embodiments also have means for communicating with external devices either through wires or wirelessly through antenna 14. Other preferred embodiments have a handle for manual dispensing of wireless tags onto an object or surface. A handheld tag applicator preferably encodes tags and wipes them from the release liner onto a desired surface. Other preferred embodiments actively transfer the tag from the release liner to an object such as a carton. Active transfer means include a rotary or linear motion element that breaks the remaining adhesive bonds between a tag and the release liner, and carry the tag to a target surface.

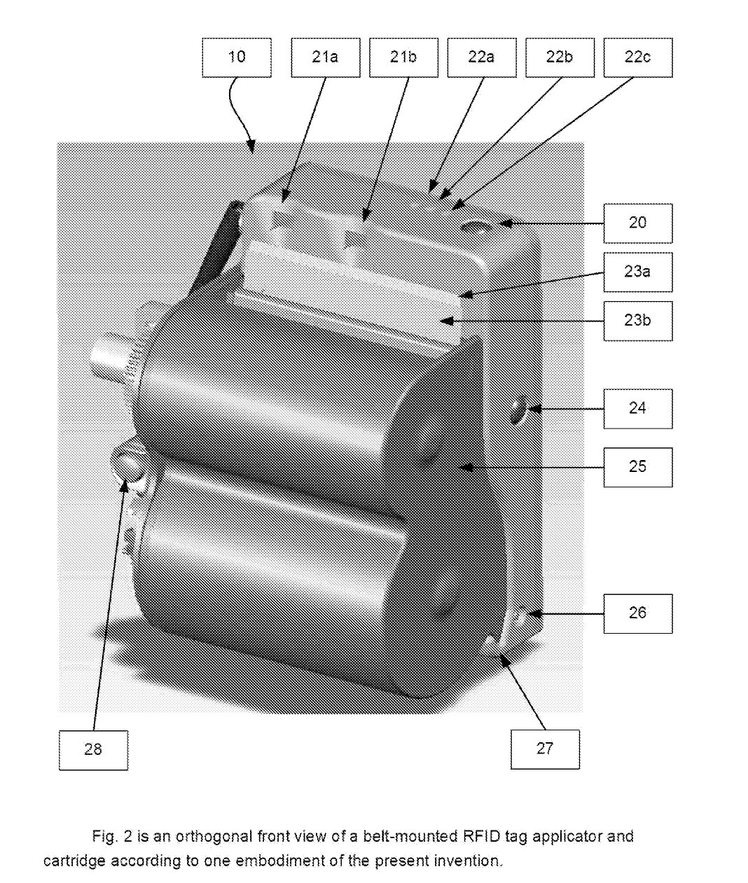

Referring now to FIG. 2, preferred portable encoder embodiments have means for interacting with a human operator, indicating when an encoded tag should be delivered, or when an encoding process should begin, or what information should be encoded into the next available tag. Encoder 10 is responsive to the presence of an operator's finger at sensor locations 21a, 21b, 20, and 24. The presence of a human finger is preferably sensed by capacitive coupling through an electrode, through a finger, and into ground reference. Sensing of a finger at sensor locations will control various functions including: power on, power off, ReDo (i.e. encoding the previous tag data payload into the next available tag), indexing to the next tag, confirming a process step to a process controller, discarding a tag to the take-up roll, turning on or off wireless communications, reading or verifying the data within a tag located outside of the material flow from source roll to take-up roll. Alternative embodiments use mechanical switches or optical sensors to detect input from an operator.

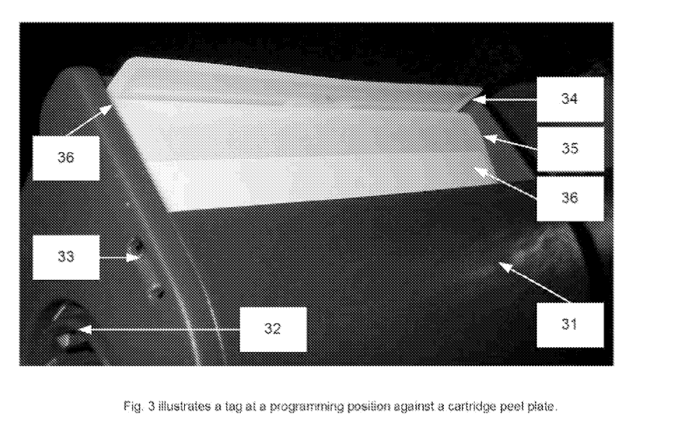

Tag 34 of FIG. 3 illustrates the preferred orientation within cartridge 31 during the interrogation and programming process. Tag 34 is retained in the upright position by peel plate 36 which is obscured from view by release liner 35. Upright tag 34 is aligned with a feed path from the source roll. Paper-backed tags or tags with sufficient shape retention are required. Certain preferred tags contain other materials that retain mechanical shape sufficient to break adhesive bonds in order to self-peel tags from their conveyance or release liner.

Peel plate 36 is retained in position by the side cover which is latched into cartridge 31 by latch 33. Certain preferred peel devices are retained in an operable position without structural connections with the tag supply or cartridge.

Hub 32 is driven clockwise in FIG. 3 to produce torque that creates tension on release liner 35 and drives it forward.

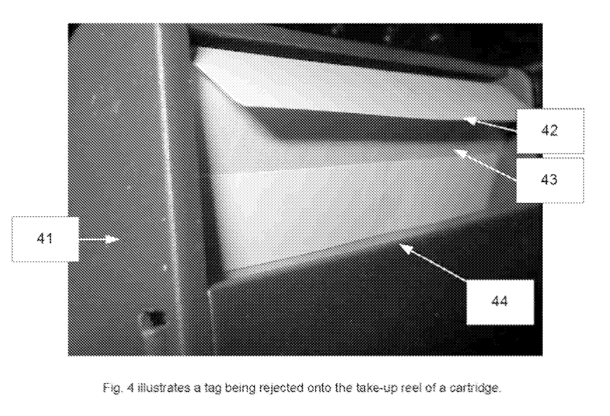

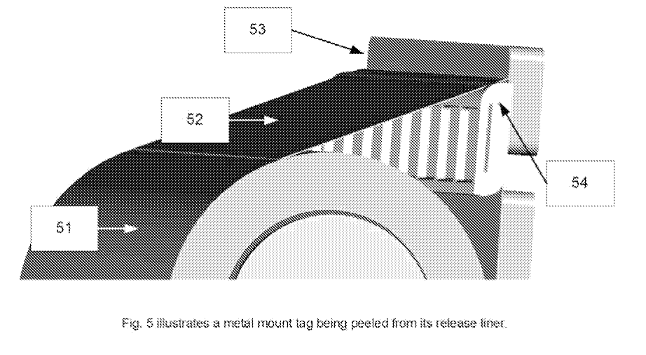

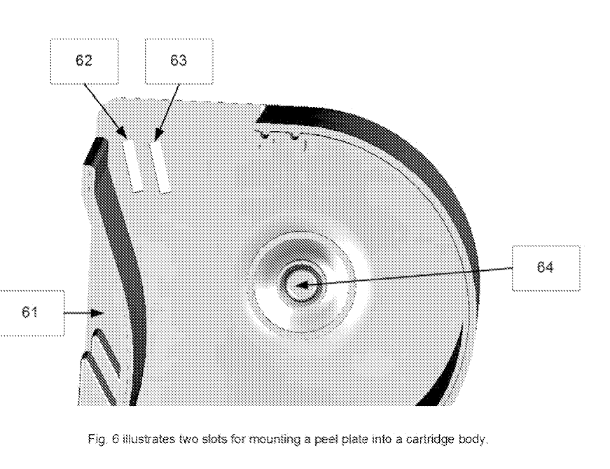

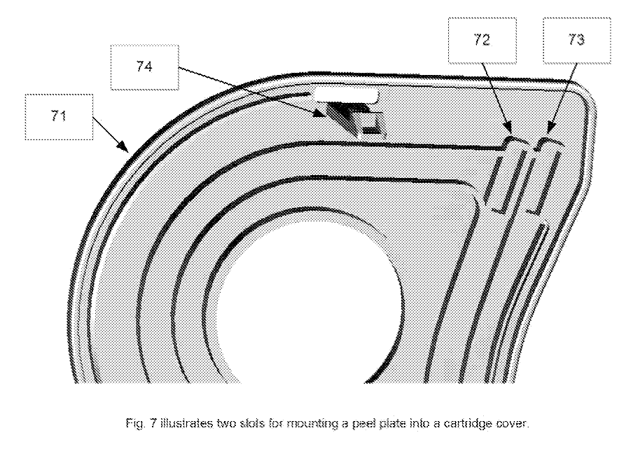

Tag 42 is shown in FIG. 4 being rejected onto the take-up roll of cartridge 41, reattaching it to release liner 43. It is important that the tag not be so tall that it hit edge 44 of cartridge 41. Release liner is collected and returned to a tag loading location which relieves the end user of the problem and responsibility of disposal of silicone-backed paper. Silicone can be collected and separated from paper fiber repulping processes.

Peel plate 36 is retained in cartridge housing 61 by slot 62 such that it is presented in close proximity to the interrogator antenna or antennae pair within the encoder. Interrogator antenna pairs are used to separate the transmit and receive signal paths and are among the preferred embodiments for mobile encoders. When antennae pairs are used as near field couplers, each antennae establishes its own tuning in conjunction with the parasitic capacitance and inductance of surrounding materials, including tag inlays. The term tuning is used to describe complex impedance matching to a transmitter, receiver, or transceiver, typically 50 ohms. When antennae are matched, reflections are minimized and more power radiates from the antenna. When antennae are mismatched, the SWR (Standing Wave Ratio) is high and much less signal radiates from it. This invention describes a dynamic tuning process whereby the tag entering a predetermined programming zone brings antennae into tune, reduces the standing wave ratio, and improves near field antennae coupling.

Certain preferred encoder embodiments utilize a tag peel device that is not structurally attached to a cartridge, and are mechanically mounted to the chassis or housing of the encoder itself. The primary advantage to a peel plate that is mounted to the chassis or to the encoder housing is that the cartridge does not have to carry a mechanical load sufficient to withstand the web tension created by the drive reel and take-up reel. The result is that the cartridge could be fabricated from materials that offer less structural strength than plastics or metal materials, including disposable or biodegradable materials. Embodiments of this invention that are based on disposable or biodegradable materials offer users the option of an earth-friendly recycling method that does not involve the return of cartridges to a limited number of specialized facilities for reprocessing used cartridges. For example a one-time use cartridge could be designed to be opened by a user once the tags are all consumed, allowing the user to separate the spent release liner or other conveyance web from the cartridge housing itself, enabling the user to deposit each type of material into different recycle or waste streams.

Referring back to FIG. 3, the position of peel plate 36 is preferred for tags that are thin. Peel plate 36 ensures that tags are not mechanically stressed when tags are commissioned. It peels the release liner away from the tag, as opposed to peeling the tag away from the release liner, whereby risking mechanical damage to the tag.

Tag 53 is a tag that mounts on and identifies a metal object. Tag 53 is preferably comprised of a layer of adhesive-backed foam as a dielectric spacer between the antenna and the metal that it is attached to. Tag 53 is presented for interrogation and programming at the preferred position shown in FIG. 5 whereby the release liner 52 is pulled toward take-up roll 51 as it is peeled from tag 53 while tag 53 is retained in the upright position by peel plate 54. Plate 54 is retained by slot 63. Slot 63 is preferably about 0.2″ back from slot 62 such that the release linear approach angle and tag clearances are set properly for tags with increased thickness backing. The thickness of the foam layer may vary, and in some cases remain compressed while on the source roll, and later expanding to its full thickness after it is programmed and removed from peel plate 54. Take-up roll 51 is retained in its operating position by cup 64. A set of peel plate retaining sockets 73 and 72 are in cartridge cover 71 and correspond on the opposing side of the cartridge with slots 62 and 63 respectively. The entire cartridge is retained in compression by a set of latches, including latch 74.

Tag 34 does not bend much while release liner 35 is peeled away from the tag. It is at the peel plate 36 that tag 34 is the most spatially separated from the others. It is at this point that near field coupler 84 and tag 34 together become tuned for a good impedance match to the interrogator. Encoding the tag that is about to be removed is preferred over embodiments where tags are encoded considerably upstream of the tag removal point; this is because it is simpler to remove a tag immediately after successful encoding rather than manage a queue of encoded tags. When there are no RFID tags in the vicinity of the peel plate, the VSWR of coupler 84 is likely to exceed 6:1. However when an RFID tag enters the region around the peel plate, the VSWR may drop to under 2:1, coupling a large part of the RF energy from the RFID interrogator into the RFID tag that is located at the peel plate. Helical near field coupler 84 is used to concentrate magnetic flux in an area behind the peel plate. It is preferably connected to interrogator 81 by microstrip 83 and a coaxial connector. Helical element 84 and microstrip 83 are surrounded by ground plane 82. Passive electronic elements such as resistors, capacitors, and inductors may be soldered onto the microstrip antenna feed to modify the input impedance of the antenna or to create a filter. For example a PI filter can be constructed from an inductor and two flanking capacitors to the ground plane. In a preferred embodiment, a resistor is used to load the antenna when it is unmatched. A resistor is soldered between the microstrip and the surrounding ground plane. Preferred values range from 100 to 1000 ohms, with a nominal preferred value of 390 ohms.

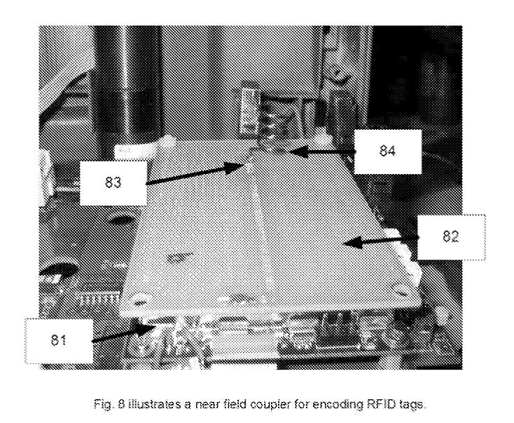

The orientation of the major axis of the helical coupler can be either horizontal or vertical. A vertically oriented helical coupler is shown in FIG. 8. A horizontally oriented helical coupler is preferably oriented along an axis that is parallel with the major axis of tag 34. It is important that the helical coupler be positioned in close proximity to the peel plate so that the RF power of the interrogator can be reduced to a range between 6 dBm to 12 dBm. Vertically oriented helical coupler 84 terminates at its distal end at a point near the part of the plastic housing that is directly opposite the preferred tag programming zone on the other side of the plastic housing. Coupler 84 preferably launches from microstrip 83 such that it emerges from the printed circuit board at an angle with a tangent that is parallel to the short edge of the printed circuit board to which ground plane 83 is bonded. Concentrating a small inductive coupling field, while minimizing the electric field, helps to reduce the RF field strength reaching neighboring tags; and hence reduces the probability of coupling with tags that are not in the immediate vicinity of the peel plate. As described in the paragraph above that describes parasitic antenna tuning, when there is no tag at the peel plate location, coupler 84 becomes a poor impedance match to interrogator 81, and little RF energy radiates, reducing unwanted stray RF and unwanted tag couplings. In other words, the complex parasitic impedance of the tag is required for the antenna, antennae pair, near field coupler, or couplers to become tuned enough to successfully energize and communicate with a wireless transponder that is presented into the programming field.

The carbon content of the plastic housing that is shown in the background of the photo of FIG. 8 also plays an important role in coupling helical element 84 to tag 34. Carbon conducts radio frequency energy, altering the shape of the wave front that emanates from near field coupler 84 and from the signals reflected from the nearby tag or tags. The amount, position, and orientation of plastic parts containing carbon affect how a passive RFID tag is energized and how the backscattered signals return to the interrogator; the same is true for active tags and wireless sensors.

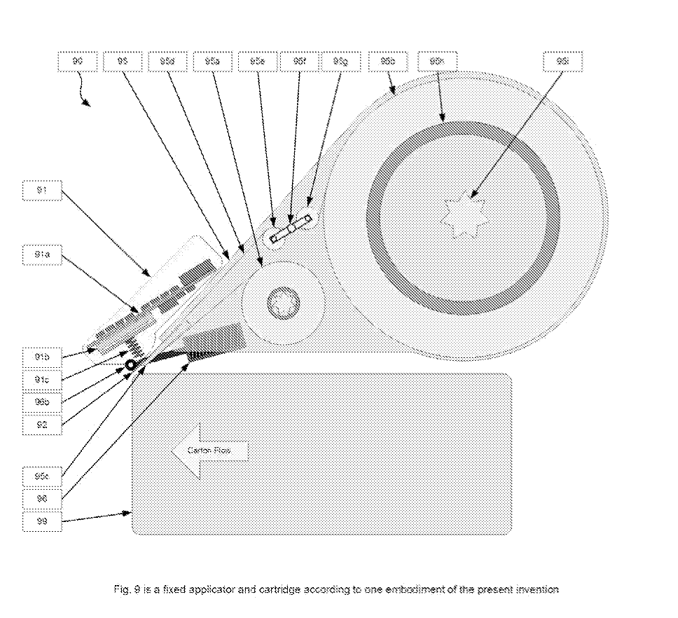

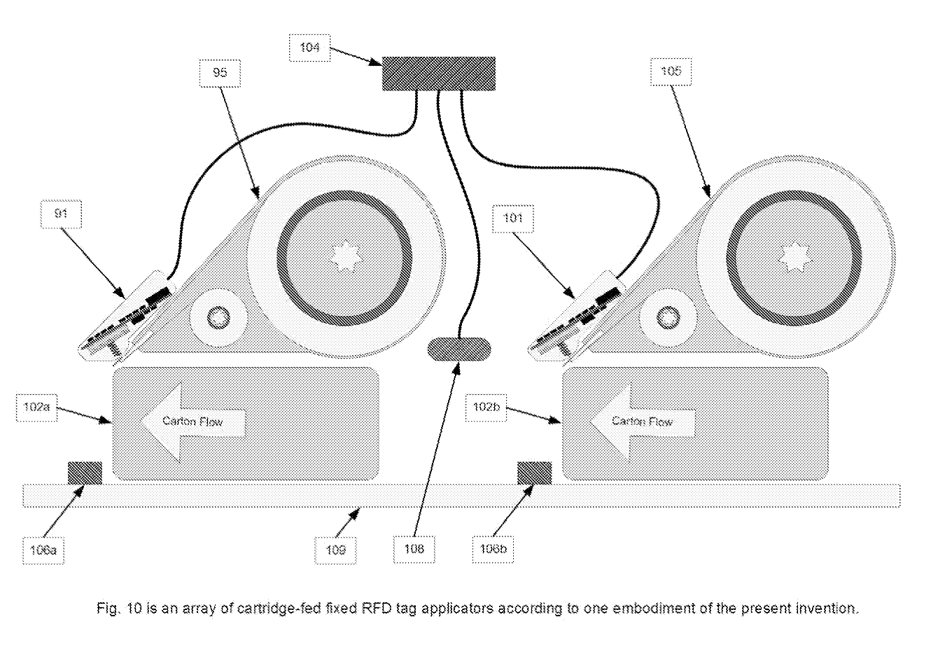

FIG. 9 is a diagrammatic view of a fixed applicator assembly 90 comprised of applicator 91 and cartridge 95. The housing of cartridge 95 preferably protects RFID tags and wireless sensors encased therein from unauthorized interrogation, ESD, mechanical damage, and in certain preferred embodiments the housing of cartridge 95 also protects tags from X-Rays and Gamma Radiation. In certain preferred embodiments, the housing of cartridge 95 contains regions of metal, carbon, conductive plastic, metal-plated plastic, or some other inexpensive, protective, mass-producible material. Applicator 91 and cartridge 95 are preferably mounted onto a supporting structure that is not illustrated in FIG. 9. A support structure enables applicator 91 and cartridge 95 to be positioned at a height above the flow of cartons and goods to be tagged. The support structure preferably affords lateral adjustments to align applicator 91 and cartridge 95 to a position on each carton or goods. A different mounting structure is used to operate applicators 91 and 101 in another plane, such as a vertical plane that is rotated 90 degrees from the horizontal plane shown in FIGS. 9 and 10.

Preferred embodiments of applicator assembly 90 maintains a controlled amount of tension in release liner 95d web by a variable torque brake/closed loop motor control assembly in combination with a low inertia tension device. Initial tension in the release linear will begin at the supply roll by monitoring diameter and/or low inertia tension device position. Motor actuation and/or brake torque will be adjusted as per the feedback device. The low inertia tension device will be used to provide a more consistent tension in the release linear in high speed indexing application. The low inertia device allows for quick start and stop indexing accommodating positioning necessary for tag processing at a high rate of speed at variable tag pitches. Feedback controls instruments and mechanical control devices are preferred to be external with proper interface to reduce complexity of cartridge.

Preferred embodiments of applicator assembly 90 maintains a controlled amount of tension in release liner 95d web by a disk brake assembly and a constant tension device such as a dancer. Some common types of dancers are pivot arm, linear, or rotational. Rotational dancer 95f is comprised of rollers 95e and 95g that rotate around a common axis at dancer 95f. A disk brake assembly is preferably located behind hub core 95i wherein brake pads are mounted in a bearing housing and rub against an exposed face of a disk brake. Braking torque is controlled by a selected number of installed brake pads, all having a certain coefficient of friction between themselves the disk, and the force exerted by a spring working through a spring retainer pushing against a tension nut that is adjusted to achieve a desired amount of braking force. A recoil spring provides a consistent amount of tension in release liner 95d through hub core 95i and source roll 95b. The recoil spring also provides tension in release liner 95d when the drive motor is stopped or run in reverse for short distances.

Take-up roll 95a is prevented from rolling backwards through the use of a one-way bearing which consists of needle bearing within a bearing housing. Within a prescribed range of reverse torque, the needle bearing will jam, whereby preventing the tag roll from rolling in the reverse direction. Forward motion of take-up roll 95a is allowed on the one-way bearing when the motor is energized in the forward direction. A preferred embodiment utilizes a direct drive motor with position feedback.

Release liner 95d begins to peel from tag 92 at peel plate 95c when it is advanced forward past the distal end of peel plate 95c. A sensor detects the location of tag 92 to control the movement and stopping position of the tags. Near field coupler 91c interrogates and encodes tag 92. Near field coupler 91c preferably couples with tag 92 with a localized magnetic field, and with the least amount of electric field as is practical. Preferred embodiments of near field coupler 91c are comprised of a helical structure of wire. In preferred embodiments the wire is solid core magnet wire having insulation on the exterior surface. The major axis of helical near field coupler 91c is either vertical from the ground plane, or horizontal to it, parallel with the major axis of the antenna of tag 92. Interrogator 91b can be of any shape, but is generally located in close proximity to near field coupler 91c and its associated ground plane.

Interrogator 91b is powered and controlled by a microcontroller integrated into encoder applicator control board 91a within a housing of applicator 91. Interrogator 91b is commercially available from WJ Communications, Inc. of San Jose, Calif., SkyeTek, Inc. of Westminster, Colo., Sirit Technologies of Toronto, Ontario Canada, or ThingMagic, Inc. of Cambridge, Mass.

Certain preferred embodiments of applicator assembly 90 utilize tag attach roller 96b to apply a downward force on top of tag 92 at a precise time as determined by when roller 96b is retracted by cylinder 96. Cylinder 96 is either electrically or pneumatically actuated. In preferred embodiments cylinder 96 is a solenoid. Roller 96b retracts only after tag 92 has been successfully encoded, and is synchronized with the movement of carton 99 to adhere tag 92 onto a preferred location of the face of carton 99 with a high degree of accuracy.

Sensor 106a of FIG. 10 generates signals that correspond to when a carton passes a certain position on conveyor 109. Signals from sensor 106a are used to trigger applicator 91 to apply an encoded RFID tag onto carton 102a at a precise time and location while it is moving on conveyor 109. Signals from sensor 106a are routed directly into applicator 91 or alternatively through a device such as a programmable logic controller (PLC) that also maintains control of the motion of conveyor 109 and can take into account changes in conveyor velocity.

Cartridge 95 plugs onto fixed applicator 91 to replenish a supply of wireless RFID tags or wireless sensors. Source roll 95b is wound onto core 95h, and unwinds using release liner 95d as a leader onto take-up roll 95a. Back tension is provided through a reverse torque or a brake at hub core 95i. Peel plate 95c holds tag 92 in a position within the magnetic field of near field coupler 91c.

For online applicators, a key benefit of this novel cartridge-based design is that the cartridges can be changed out without disrupting, halting, or reducing packaging line throughput. This is preferably accomplished by ganging together several cartridges to cooperatively work together to encode and apply tags when other cartridges in the system have been depleted. Certain preferred embodiments use several cartridges working together to deliver an aggregate throughput that cannot be achieved with a single cartridge. For example, one cartridge can deliver up to one tag per second, but two cartridges can deliver twice that throughput. Adding a third applicator and cartridge can add either additional throughput or a degree of redundancy to maintain line speeds when one applicator is unable to encode and apply tags.

Each cartridge of a fixed applicator system utilizes a tag transfer mechanism that peels and removes tags from release liner and transfers tags one at a time to a target location on a carton or some other object while it is moving.

Controller 104 coordinates the encoding activity of applicator 91 and applicator 101, drawing from tags housed in cartridges 95 and 105 respectively. Controller 104 assures that each carton that should receive an encoded tag actually does receive an encoded tag. A preferred means of sharing the encoding load uses reduces the carton-tagging rate (measured for example in units of cartons per minute) to a level that can be reliability maintained by an individual applicator 91 or 101. A preferred embodiment utilizes applicators 91 and 101 to each apply encoded tags to every other carton, alternating as the cartons move under or next to them. The combined capacity of the pair is at best twice that of a single applicator. A rating of 60 cartons per minute per applicator can then be extended to 120 cartons per minute, disregarding downtime. In another preferred embodiment, three applicators provide a combined capacity of 120 cartons per minute, with the ability for any one of them to be briefly taken out of service for a cartridge changeover.

RFID interrogator 108 is used in certain preferred embodiments as a means of verifying that the applied tag is functional after being applied to carton 102b.

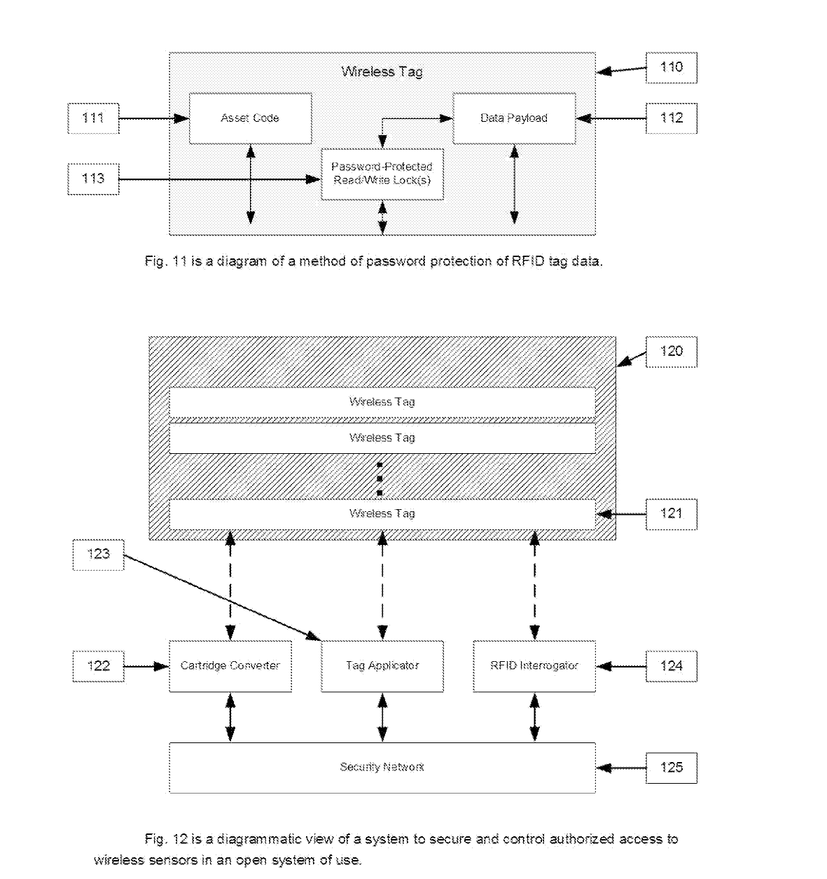

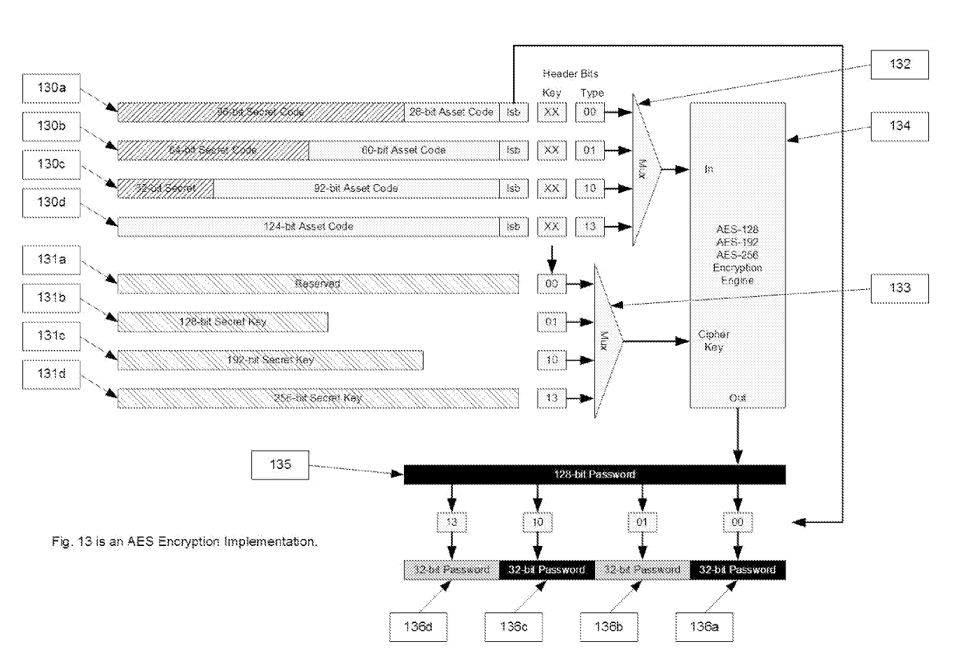

Tag security is achieved through the use of passwords that are required to unlock sections of tag memory for access and/or rewriting as is shown in FIG. 11. Data payload 112 of tag 110 may also be known as EPC memory or Unique Item Identifier (UII) in some implementations. Asset code 111 may be located within another memory partition that may be referred to as user memory or TID in some preferred embodiments. TID is a memory bank which is preferably encoded with information pertaining to the capabilities and model number of the RFID chip in the tag. In preferred embodiments, TID also contains a unique serial number and is capable of serving as a unique asset identification number (asset code). Password locking mechanism 113 is shown in this preferred embodiment to protect data payload 112, but other configurations exist to protect other memory partitions using other security means.

Unique passwords are preferably generated by reading information from the tag and processing that information through an encryption engine to generate the required password. In a preferred embodiment, a public key is stored on each RFID tag 121 within cartridge 120, 95, 41, 31, 25, or 12, and a private key is hidden within each tag encoder/applicator 123 that is intended to access or rewrite tag 121. A preferred encoder/applicator 123 embodiment uses one private key for each authorized tag supplier. Cartridge conversion facilities having at least one cartridge converter 122 are issued an identical private key for locking tag 121 and others within each cartridge 120. Cartridge conversion facilities and machines preferably apply preprinted logos, human readable codes, or bar codes onto tag 121 and others like it before they are loaded into cartridge 120. Human readable codes may be comprised of information relating to manufacturing location, machine number, and date in order to create a unique number that can be used as an index to recover information about tag 121 if it later fails, or is the subject of a pedigree investigation.

In certain preferred embodiments, foam is attached as cartridges are loaded in order to create fat (i.e. thick) tags that perform well when mounted onto metal objects or containers holding liquids. Adhesive-backed foam is placed between the tag and the release liner as a dielectric spacer. Fat tags are then encoded at a point of use, peeled from release liner, and applied to most any object, including metal objects or containers full of liquid.

Asset code 111 is preferably used as a permanent identifier that is used to construct a unique data item used as an input to an encryption engine. In this manner no matter what data is stored in data payload 112, tag 110/121 can be unlocked for access. Asset code 111 also has a second purpose for authentication. RFID interrogators like interrogator 124 is preferably used to read both data payload 112 and asset code 111 to authenticate tag 110. Counterfeit tags are readily detectable if the two numbers are not found to be previously associated in a trusted database, or to not have been found paired elsewhere, or without an approved tag pedigree. RFID interrogator 124 may be located in a waste stream choke point such as a carton baler or a paper mill that repulps cartons having RFID tags attached to them.

In 2001, the National Institute of Standards and Technologies (NIST) adopted the Rijndael algorithm as the Advanced Encryption Standard AES. The AES algorithm began immediately to replace the Data Encryption Standard DES which was in use since 1976. AES excels DES at improved long-term security because of larger key sizes (128, 192, and 256 bits). Another major advantage of AES is its ability of efficient implementation on various platforms. AES is suitable for small 8-bit microprocessor platforms, common 32-bit processors, and it is appropriate for dedicated hardware implementations (additional information available at http://csrc.nist.gov). Therefore a modern microcontroller or microprocessor with a tens of kilobytes of memory, a portion of which is random access memory (RAM) is suitable for storing tag data, passwords, encrypted data, unencrypted data, and enough space to perform mathematical and logical operations that are required for an encryption engine, including one as sophisticated as AES. RAM is preferably used with non-volatile memory to store different types of data that require varying degrees of persistence. For example keys require more persistence in memory than intermediate calculation results of an AES round. Machine memory is used to store data and variables as data sets are moved through a secure process of transferring data sets to and from programmable tags and to safely convey related data sets and related information to and from a remote host computer or other controlling device with minimal risk of security compromise.

According to NIST, a typical 8-bit microcontroller requires about 8,000 instruction clock cycles to run the AES algorithm. Most operations of AES are byte-oriented; and can be executed efficiently on 8-bit processors. The Advanced Encryption Standard AES is a symmetric block cipher. It operates on 128-bit blocks of data. The algorithm can encrypt and decrypt blocks using secret keys. The key size can either be 128-bit, 192-bit, or 256-bit. The actual key size depends on the desired security level. The different versions are most often denoted as AES-128, AES-192, or AES-256. Today, AES-128 is predominant and supported by most hardware implementations.

A key aspect of the AES algorithm is its simplicity, which is achieved by two means: the adoption of symmetry at different levels and the choice of basic operations. The first level of symmetry lies in the fact that the AES algorithm encrypts 128-bit blocks of plaintext by repeatedly applying the same round transformation. AES-128 applies the round transformation 10 times, AES-192 uses 12, and AES-256 uses 14 iterations.

A preferred embodiment for securely generating passwords where end when needed by authorized equipment and persons is to distribute one or more private (i.e. secret) keys to be embedded in tag encoders and applicators. Public keys can be comprised of data carried on the tag in any of the various memory banks, including: TID memory, EPC memory, user memory, or other memory partitions that may be referred to by other names. The public key and private key are then used by the AES encryption engine to generate a 128-bit result which can be used to derive a 32-bit password. A preferred way of using the 128-bit result is to break it into four 32-bit passwords to unlock memory partitions. Other passwords sizes can also be generated by using all or part of a 128-bit AES result.

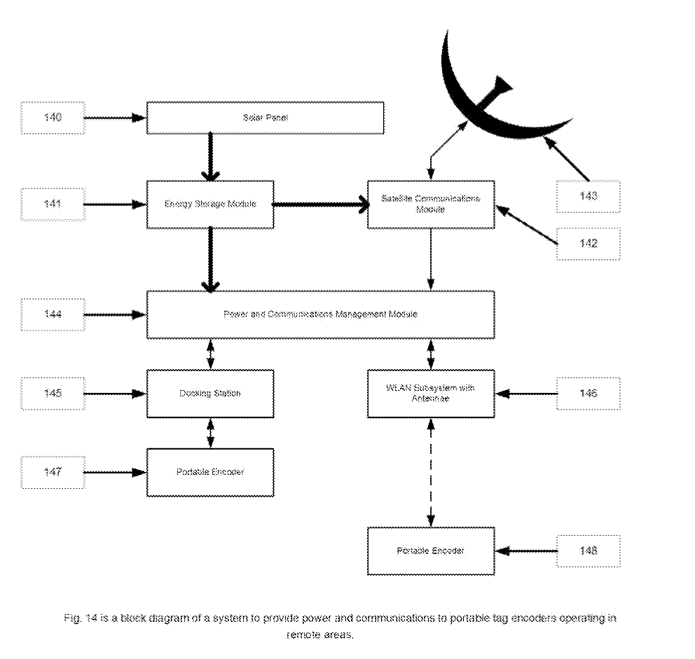

Referring now to FIG. 13, AES encryption engine 134 operates with 128, 192, or 256 bit encryption keys. Inputs 130a-d to encryption engine 134 are comprised of a variable length asset code and fixed length header bits that are stored in each RFID tag. If the total of those bits is less than 128, the remaining bits are provided from a bank of secret codes that are embedded in each applicator or tag encoder. Input models for each asset code length are shown as inputs 130a-d. Input 130a is comprised of 28 bits, 130b of 60 bits, 130c of 92 bits, and 130d of 124 bits.

The choice of the key length is determined by two additional input header bits stored on the tag that control multiplexer logic 133 to select a key length and associated algorithm of 10, 12, or 14 round iterations for AES-128, AES-192, and AES-256 respectively.

Two additional header bits within asset codes 130a-d control selection logic 132 to select from among four possible input types the composition of the 128-bit input to encryption engine 134. Input 130a is of type ‘00’ and is comprised of a 28-bit asset code, 4 header bits, and a 96-bit secret code that is embedded in the applicator. Input 130b is of type ‘01’ and is comprised of a 60-bit asset code, 4 header bits, and a 64-bit secret code that is embedded in the applicator. Input 130c is of type ‘10’ and is comprised of a 92-bit asset code, 4 header bits, and a 32-bit secret code that is embedded in the applicator. Input 130d is of type ‘11’ and is comprised of a 124-bit asset code, 4 header bits, and no secret code.

Asset codes are preferably stored in a memory partition that is separate from the EPCglobal electronic product code or other similar primary identifier. Asset codes are preferably semi-permanent and are intended to survive more than a single use of the tag. Asset codes are preferably comprised of information that may include information about where and when the tag cartridge was originally encoded and assembled. In certain preferred embodiments such information includes facility number, machine number, time, date, and serial number or a pseudo random number. Alternatively, the asset number may be at least partially comprised of the tag identification number generated and permanently encoded by the manufacturer of the RFID chip. Serialized asset numbers enable encoder/applicator 10 to read each tag to determine which tag is being programmed and to report to a host or to an operator the number of tags that remain in cartridge 25.

A preferred use of encryption keys is to protect tagged goods, particularly in supply chains from the use of counterfeit tags or cartridges. Each encoder or applicator can support multiple key types. Multiple keys support multiple tag or cartridge sources. Encryption key 131a is of unspecified length. Key 131b is a 128-bit secret key that is embedded in each applicator and encoder that supports a certain type or brand of tag cartridge. Key 131c is a 192-bit AES key. Key 131d is a 256-bit AES key.

128-bit password 135 is the output of encryption engine 134. Password 135 is broken down into four 32-bit passwords 136a-d under the control of the two least significant bits of the asset codes. In this manner, a single asset code can be used to generate four passwords, each of which can be used to access a separate RFID tag.

Tag encoder 10, 90, or 123 preferably do not encode any unsecured RFID tags. Preferred embodiments of tag encoder 10, 90, and 123 verify that each tag is locked and requires a prescribed level of security in order to write to it. Unsecured tags are preferably rejected at some operational level. The intent is to develop a market only for secure tags that are traceable to their origin to support a trusted pedigree for end users.

Tag data security is also provided by securing the tag encoder/applicator 123 against malicious code such as a virus. The main purpose of protecting applicator 123 is to ensure that RFID tags never contain information that can potentially disrupt the proper operation of interrogators and data processing equipment.

Preferred applicator 123 embodiments execute anti-virus code in a protected portion of memory that can only be modified by opening a secure electrical access panel 16, attaching a special debug/download pod, and erasing the entire program before downloading a new program. Such capabilities are provided by microcontrollers from Freescale Semiconductors, Inc. of Austin, Tex. Another aspect of the preferred embodiment is that program updates to unprotected memory locations are made through a wireless download means using a trusted program operating out of protected memory. A trusted anti-virus program downloads and verifies that the downloaded program conforms to certain algorithmic rules. Anti-virus code scans incoming program updates to identify malicious code segments and/or to verify that a program has a predefined signature. A program signature can be identified by running all or part of program machine code through an algorithm that produces a required mathematical result. Any program that fails this test can be rejected as being corrupt.

Preferred embodiments of tag applicator 123 have the ability to execute one program while downloading and verifying another before transferring control to it. A preferred method is to load the new program and scan it either as it is arriving or after it has been loaded into a section of memory.

The protected memory preferably contains secret (private) keys 131a-d, secrets codes 130a-d, secret algorithms, anti-virus scanning code, a unit serial number, and a program loader. The program loader is preferably invoked by a host command. Host commands are preferably ASCII commands or XML commands.

The general form of a host XML command is:

<item>

<command=”command”/>
<type=”type”/>
<length=”length”/>
<data=”data”/>

<item/>

Certain preferred embodiments use tags, transponders, or wireless sensors that are preprinted with certain symbols which may include: barcodes, an EPCglobal seal, or other identification marks. Preprinted symbols that carry digital information, such as a linear or two-dimensional barcode may reference a unique number or a data storage location on a network. A preferred method of encoding such a storage location is to use a uniform resource locator (URL). RFID tags located within or attached to cartridge 25, 95, or 120 preferably carry information that enables encoder 10, 90, or 123 to associate each tag with each uniquely and sequentially pre-printed barcode. In a preferred embodiment, the first tag to emerge from cartridge 25 is pre-encoded with data that describes the data that is encoded into the barcode that is preprinted on that RFID tag. Each subsequent tag is preferably encoded with data that is a logical progression from the previous tag, and in many cases is part of a consecutively numbered series. In another preferred embodiment, a more secure method uses a pseudorandom numbering sequence to enumerate the tags.

Tag encoder 10, 90, or 123 will read data from a memory partition within each tag that may include: a header, a total tag count field, a tag number (1 to about 1000), a cartridge identifier, a field that contains the running count of bad tags encountered so far in that cartridge, a field that contains the total number of bad tags in that cartridge, a field that tells the mobile encoder how to process the tags in this cartridge, a field that contains the cartridge conversion date and time, a field that identifies the conversion facility and machine number, a field that enumerates and links each tag to a bar code on the corresponding tag, check digits, CRC, or other error detection and correction methods. Certain preferred embodiments use asset identifiers that are programmed into the transponder memory at the chip foundry before dice are attached to antennae to form inlays. The primary advantage is processing speed.

Mobile encoders at least write data to the first and the last tags on a cartridge. The data shall be written to a special secure tag memory partition if possible. The stored data will preferably include: the unique PAD identification number, an operator identification number, the location, date, and time when it is provided by the host system, and an encrypted authentication code.

Operation of tag encoders disclosed herein may require support infrastructure that may not typically be in place in remote parts of the world where products are manufactured. As a minimum, the encoders require a long term supply of power. In the absences of line power, DC power can be made readily available through solar panels, fuel cells, or from a generator that is powered by fossil fuel or other hydrocarbon molecules. A preferred embodiment for a solar-powered remote encoder support infrastructure is shown in FIG. 14. Solar panel 140 is used to charge a battery in solar Energy Storage Module 141. The heavy arrows depict paths along which power flows to operate two major subsystems: DC power distribution to tag encoders 147 and 148, as well as to Satellite Communications Module 142. A preferred embodiment where terrestrial telephone, cable, or wireless services are available substitutes Satellite Communications Module 142 with a telephone, cable modem, or wireless interface. Preferred services may include dial-up modem connections, cable television modem connections, PCS, GSM, CDMA, TDMA, or other subscriber-based communications services.

Satellite dish 143 is appropriately sized and directed skyward for an earth-orbitting satellite that it communicates with. Various uplink and downlink bands may be used and processed through Satellite Communications Module 142 including S-Band (approximately 2.2 GHz) and X-Band (approximately 7.2 to 8.5 GHz) satellite communications frequencies. A 60 cm diameter parabolic dish antenna may be representative of the size and gain required for satellite communications. Power and Communications Management Module 144 regulates all activity required to provide power and communications for the tag encoders operating in the immediate area. One or more docking stations 145 are provided for portable encoder 147 and others like it to acquire power and in some versions exchange data through wired connections. Fixed Applicator Device 149 exchanges data directly with Power and Communications Management Module 144. A preferred means of providing power and communications to Fixed Applicator Device 149 is through a Power-Over-Ethernet connection.

This novel means includes portable and stationary tag encoders that use preloaded tag cartridges as a convenient means for tag handling and replenishment.

While the invention has been particularly shown and described with reference to certain embodiments, it will be understood by those skilled in the art that various changes in form and detail may be made without departing from the spirit and scope of the invention.

We claim:

1. A media thickness-tolerant wireless tag encoder comprising:
an RFID interrogator means;
a plurality of programmable tags having a release liner, the tags arranged in a protected modular supply means, the supply means adapted to be selectively coupled to the RFID interrogator means;
an associated peel plate disposed such that tags separate from the release liner in order to expose the tag's adhesive layer; an encryption engine to grant access to secured programmable tags, the encryption engine having communication means with the RFID interrogator means to enable tag-data, passwords, or security elements to be selectively encrypted, locked, or unlocked on any one of the supply of programmable tags;
a motor means for feeding any one of the programmable tags to a position that is in proximity to the RFID interrogator means, the motor means further adapted to enable the peel plate to remove the release liner from any one of the programmable tags;
and a machine memory means in communication with the encryption engine, the machine memory means adapted to contain a plurality of data-sets, each data-set corresponding to an associated programmable tag from the plurality of programmable tags.

2. The RFID interrogator of claim 1 further comprising a near field coupler means for encoding spatially selected wireless tags.

3. The near field coupler of claim 2 further comprising a helical coil backed by a ground plane, the helical coil adapted to direct electromagnetic radiation toward wireless tags.

4. A wireless tag encoding means without any printing means; for the purpose of securely encoding and dispensing a protected modular supply of writable RFID tags.

5. A cartridge for containing a plurality of programmable RFID tags comprising:
a means for coupling the cartridge to a mechanical drive means; and
a means for selectively exposing RFID tags to desired radio frequency signals for writing data into RFID tags while they are contained within the cartridge.

6. The cartridge of claim 5 further comprising a peel plate means for separating the plurality of tags from a flexible carrier material.

7. The flexible carrier material of claim 6 further comprising a low surface-energy release liner that allows a pressure sensitive adhesive to detach from it.

8. The cartridge of claim 6 further comprising a supply of thick adhesive-backed tags adapted for identifying and tracking objects comprised of metal or containers of liquid.

9. The cartridge of claim 6 further comprising means for dispensing encoded wireless tags onto containers moving in a material handling system.

10. The cartridge of claim 9 adapted for use in an environment that includes a plurality of containers on a continuous feed mechanism, the cartridge comprising means for replacing the cartridge with a second cartridge without stopping the movement of containers.

11. The cartridge of claim 6 that does not contain a take-up roll.

12. The cartridge of claim 6 further comprising a take-up roll of flexible carrier material.

13. The cartridge of claim 5 further comprising primarily earth-friendly disposable or biodegradable materials.
